(19) United States
(12) Patent Application Publication
(10) Pub. No.: US 2022/0307828 A1
(43) Pub. Date: Sep. 29, 2022

(54) Wireless differential barometer and altimeter

(71) Applicant: Yanik Freeman, Whitehorse (CA)

(72) Inventor: Yanik Freeman, Whitehorse (CA)

(21) Appl. No.: 17/685,850

(22) Filed: Mar. 3, 2022

Related U.S. Application Data
(60) Provisional application No. 63/167,630, filed on Mar. 29, 2021.

(51) Int. Cl. G01C 5/06

(52) U.S. Cl. CPC G01C 5/06

(57) ABSTRACT

A method and system for using MEMS barometers for correcting for changes in environmental pressure to calculate residuals and derived altitudes.

### FIELD OF THE INVENTION

The invention relates to a wireless MEMS barometric system for correcting for environmental changes in pressure to calculate residuals and derived altitudes.

### BACKGROUND OF THE INVENTION

MEMS barometers are commonly used to measure atmospheric pressure and to derive altitudes from these measurements. In traditional systems elevations are calculated based on pressure readings for a single unit and are subject to the errors inherent with naturally occurring environmental changes in pressure.

For applications such as indoor elevations, building pressurization monitoring and altitude references for drones a greater degree of accuracy is required and there is a need for a cost-effective solution.

### BRIEF SUMMARY OF THE INVENTION

The invention provides residual atmospheric pressures and derived elevations at a rover using corrections transmitted wirelessly from a stationary base.

When the rover and base are within reasonable proximity to each other they are subjected to the same atmospheric forces. As pressure changes with time it introduces a systematic error which degrades the accuracy of the rover readings. If a fixed reference base is subjected to the same forces it can be used to correct the readings and provide accurate results.

In the first application of the invention the rover outputs a corrected elevation as it is raised or lowered relative to the ambient atmospheric pressure.

In the second application of the invention the rover outputs a corrected pressure inside an enclosed space such as a building relative to the ambient atmospheric pressure.

### BRIEF DESCRIPTION OF THE DRAWINGS

FIG. 1 is a diagram of the process and forces used by the invention to calculate a differential altitude.

FIG. 2 is a diagram of the process and forces used by the invention to calculate a differential pressure.

FIG. 3 is a diagram of the system.

### DETAILED DESCRIPTION OF THE INVENTION

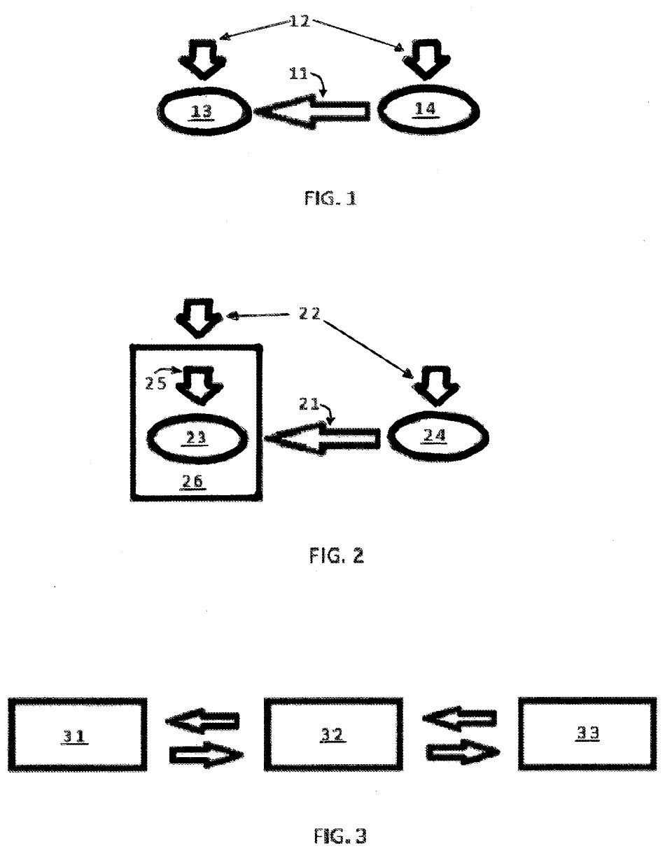

FIG. 1 illustrates floating rover 13 elevations calculated based on corrections 11 wirelessly transmitted from a fixed base 14. In this application the rover outputs a corrected elevation as it is raised or lowered relative to the ambient atmospheric pressure 12. When used inside an enclosed space such as a building both units must be located within in order to be subjected to equivalent ambient forces.

FIG. 2 illustrates fixed rover 23 pressure difference based on corrections 21 wirelessly transmitted from a fixed base 24. In this application the rover outputs a corrected pressure 25 inside an enclosed space 26 such as a building relative to the ambient atmospheric pressure 22. The base must be located outside the enclosed space in order to cancel outer pressurization effects and determine inner pressurization residuals.

The circuitry in the rover and base are the same and these can be used interchangeably. FIG. 3 illustrates the system is comprised of an integrated microcontroller (MCU) 32 to process barometer 31 data and a transceiver 33 to wirelessly communicate. The base transmits the barometric pressures to the rover which integrates this data with local barometric pressures to calculate and output residual pressures and derived altitudes.

A differential rover pressure is calculated based on the formula: DRP=ARP+(DBP−ABP) where DRP is the corrected differential rover pressure, ARP is the absolute rover pressure, DBP is the base pressure fixed reference datum and ABP is the absolute base pressure. DBP is determined by averaging ABP values for a set period of time prior to calculating a DRP solution.

Once a DRP solution is computed it can be converted from millibars (mb) to an altitude in feet (ft) using the conventional National Oceanic and Atmospheric Administration (NOAA) formula: 145366.45*[1−(DRP/1013.25)\hat{ }0.190284].

Provided the base remains stationary, tests have shown that the results are generally stable over time as the ambient atmospheric pressure naturally changes.

1. A method of improving the accuracy of a MEMS barometer comprising: A) obtaining an average fixed base pressure datum (DBP) by averaging pressure readings for a set period of time; B) obtaining an absolute base pressure at time t (ABP); C) obtaining an absolute rover pressure at equivalent time t (ARP); and D) calculating a differential rover pressure (DRP) using the formula DRP=ARP+(DBP−ABP).

2. The method in claim 1 using an equivalent device to a MEMS barometer which outputs a barometric pressure.

3. A system for the method in claim 1 to wirelessly transmit the base data to the rover.
